(19) United States
(12) Patent Application Publication
(10) Pub. No.: US 2024/0280130 A1
(43) Pub. Date: Aug. 22, 2024

(54) TAPERED THREAD-FORMING FASTENERS

(71) Applicant: Tesla, Inc., Austin, TX (US)

(72) Inventors: Christopher Adam Antoun, Fremont, CA (US); Kenan Uslu, Fremont, CA (US); Joe Yang Chin, Santa Clara, CA (US)

(21) Appl. No.: 18/292,171

(22) PCT Filed: Sep. 21, 2022
(86) PCT No.: PCT/US2022/044247

§ 371 Date: Jan. 25, 2024

Related U.S. Application Data
(60) Provisional application No. 63/261,720, filed on Sep. 27, 2021.

(51) Int. Cl. F16B 25/00; F16B 37/12

(52) U.S. Cl. CPC F16B 25/0021; F16B 25/0078; F16B 37/127

(57) ABSTRACT

A tapered fastener adapted to be installed in an unthreaded, tapered hole in a workpiece formed of a cast material is provided. The tapered fastener can have a head and a shank. The shank can have a tapering outer face with substantially the same tapering angle as the tapered hole in the workpiece. A thread forming screw thread in the tapering outer face forms threads in the unthreaded, tapered hole as the head drives the shank into the workpiece.

### CROSS-REFERENCE TO RELATED APPLICATIONS

This application claims the benefit of U.S. Provisional Application No. 63/261,720, filed Sep. 27, 2021, the entire disclosure of which is hereby incorporated by reference in its entirety.

### TECHNICAL FIELD

This application relates in general to thread fastener members and more specifically to tapered fasteners insertable into a tapered aperture of a cast material.

### BACKGROUND

Known metallic fasteners (e.g., inserts, screws, bolts, studs, rivets, anchors, etc.) are adapted to be fitted in generally straight bores. For machined parts, bores are often drilled resulting in a uniform cross-section for the length of the bore. In contrast to bores drilled in machined parts, holes formed in cast parts may not meet tolerance requirements for installation of the fastener without post-processing.

### SUMMARY

The casting process enjoys certain advantages vis-a-vis other shaping processes such as forging, welding, stamping, rolling, extruding, etc. For example, a significant advantage of casting over machining is casting is highly adaptable to the requirements of mass production. Large numbers of a given casting can be produced rather quickly. For example, the automotive industry casts a massive number of workpieces including engine blocks, subframes, seat components (e.g., belt anchors, frames, etc.), motor housings, and transmission cases. While as-cast workpieces are generally dimensionally stable from piece to piece, challenges present themselves when cast workpieces include cast holes. While the holes can be dimensionally stable, their dimensions may vary along a depth of the hole resulting in a tapering shape. Further, cast holes can cause the workpiece to stick within the die delaying removal of the workpiece from the die.

This tapering shape of a hole can be machined straight as part of post-processing. If time and cost permits, post-processing can include machining (drilling) the hole to meet tolerance requirements for the subsequently installed fastener.

The fasteners described herein can be inserted into a cast hole without having to post-process the hole prior to insertion of the fastener. The geometry (e.g., size, shape, profile, material, etc.) of the fasteners allows the fasteners to be installed in tapering holes without post-processing (e.g., drilling). The geometry of the fastener can provide a structural attachment (e.g., engine blocks, subframes, seat components such as belt anchors and frames, motor housings, and transmission cases) for a fastener to the workpiece. Removing post-processing steps for a single mass produced cast part in the automotive industry can reduce costs and provide those cost savings to the consumer.

An aspect is directed to a tapered fastener adapted to be installed in an unthreaded, tapered hole in a workpiece formed of a cast material. Exemplary cast materials can include non-ferrous metals (e.g., aluminum, copper, lead, nickel, tin, titanium and zinc, as well as copper alloys like brass and bronze). Of course other materials (e.g., ferrous metals, plastics, etc.) also fall within the scope of this disclosure.

An aspect of the disclosure is directed to a fastener adapted to be installed in an unthreaded, tapered hole in a workpiece formed of a cast material. The fastener comprises a head having a driving arrangement and a shank comprising a tapering outer face with substantially the same tapering angle as the tapered hole in the workpiece, and a thread forming screw thread disposed in the tapering outer face and configured to form threads in the unthreaded, tapered hole as the head drives the shank into the workpiece.

A variation of the aspect above is, wherein the head has an aperture, the aperture being sized and shaped to receive a threaded fastener.

A variation of the aspect above is, wherein the shank has a generally tubular shape.

A variation of the aspect above is, wherein the shank comprises a screw thread formed inside the tubular shank and configured to receive a threaded fastener.

A variation of the aspect above is, wherein the fastener is configured as an insert.

A variation of the aspect above is, wherein the fastener is configured as a screw.

A variation of the aspect above is, wherein the fastener is configured as a double ended stud.

A variation of the aspect above is, wherein the fastener further comprises a stud sized and shaped to receive a fastener.

A variation of the aspect above is, wherein the stud is threaded.

A variation of the aspect above is, wherein the stud is plain.

A variation of the aspect above is, wherein the driving arrangement is a rachet.

A variation of the aspect above is, wherein the tapered hole in the workpiece has a tapering angle greater than 1.5 degrees.

A variation of the aspect above is, wherein a difference between the tapering angle of the workpiece and the tapering angle of the shank is no greater than 1.5 degrees.

A variation of the aspect above is, wherein the tapering angle of the shank is 4 degrees.

A variation of the aspect above is, wherein the tapering angle of the workpiece is 4 degrees.

A variation of the aspect above is, wherein the thread forming screw thread has a pitch and a depth which are substantially the same.

A variation of the aspect above is, wherein the thread forming screw thread is trilobular.

A variation of the aspect above is, wherein the tapering outer face has a maximum outer diameter greater than that of a minimum inner diameter of the tapered hole in the workpiece.

A variation of the aspect above is, wherein the fastener is forged steel.

A variation of the aspect above is, wherein the cast material is aluminum.

A variation of the aspect above is, wherein the fastener provides a structural attachment for a threaded fastener to the workpiece.

An aspect of the disclosure is directed to a threaded insert adapted to be installed in an unthreaded, tapered hole in a workpiece formed of a cast material. The insert comprises a head having a driving arrangement and an aperture, the aperture being sized and shaped to receive a threaded fastener and a generally tubular shank comprising a tapering outer face with substantially the same tapering angle as the tapered hole in the workpiece, a thread forming screw thread disposed in the tapering outer face and configured to form threads in the unthreaded, tapered hole as the head drives the tubular shank into the workpiece, and a screw thread formed inside the tubular shank and configured to receive the threaded fastener.

A variation of the aspect above is, wherein the driving arrangement is a rachet.

i A variation of the aspect above is, wherein the tapered hole in the workpiece has a tapering angle greater than 1.5 degrees.

A variation of the aspect above is, wherein a difference between the tapering angle of the Nvorkpiece and the tapering angle of the shank is no greater than 1.5 degrees.

A variation of the aspect above is, wherein the tapering angle of the shank is 4 degrees.

A variation of the aspect above is, wherein the tapering angle of the workpiece is 4 degrees.

A variation of the aspect above is, wherein the thread forming screw thread has a pitch and a depth which are substantially the same.

A variation of the aspect above is, wherein the thread forming screw thread is trilobular.

A variation of the aspect above is, wherein the tapering outer face has a maximum outer diameter greater than that of a minimum inner diameter of the tapered hole in the workpiece.

A variation of the aspect above is, wherein the threaded insert is forged steel.

A variation of the aspect above is, wherein the cast material is aluminum.

A variation of the aspect above is, wherein the threaded insert provides a structural attachment for the threaded fastener to the workpiece.

An aspect of the disclosure is directed to a method of installing a tapered fastener in an unthreaded, tapered hole in a workpiece formed of a cast material. The method comprises providing a tapered fastener having a head and shank, the head comprising a driving arrangement, the shank comprising a tapering outer face with substantially the same tapering angle as the tapered hole in the workpiece, the tapering outer face comprising a thread forming screw thread, inserting at least a portion of the shank into the unthreaded, tapered hole, and driving the fastener via the driving arrangement into the unthreaded, tapered hole to form threads in the unthreaded, tapered hole.

A variation of the aspect above further comprises pushing excess material out of the unthreaded, tapered hole by plastic deformation.

A variation of the aspect above further comprises coupling a second fastener to the tapered fastener.

### BRIEF DESCRIPTION OF THE DRAWINGS

The present inventions are described with reference to the accompanying drawings, in which like reference characters reference like elements, and wherein:

FIG. 1 is a top view of a tapered fastener in the form of an insert adapted to be installed in an unthreaded, tapered hole in a workpiece formed of a cast material.

FIG. 2 is a partial cross-section view through the threaded insert of FIG. 1 taken along lines 2-2 in FIG. 1.

FIG. 3 is a cross-section view through a workpiece that was cast with a hole configured to subsequently receive the threaded insert, of FIGS. 1 and 2.

FIG. 4 is a top view of another embodiment of a threaded insert adapted to be installed in an unthreaded, tapered hole in a workpiece formed of a cast material.

FIG. 5 is a partial cross-section view through the threaded insert of FIG. 4 taken along lines 5-5 in FIG. 4.

FIG. 6 is a cross-section view through the threaded insert of FIG. 5 taken along lines 6-6 in FIG. 5 showing a relief in a distal portion of the inside of the tubular shank to enhance packaging.

FIG. 7 is a cross-section view through a workpiece that was cast with a hole configured to subsequently receive the threaded insert of FIGS. 4-6 without post-processing.

FIG. 8 is side view of the threaded inserts from FIGS. 1 and 4 with a threaded fastener secured therein.

FIG. 9 is a bottom perspective view of the threaded insert from FIG. 8.

FIG. 10 is another bottom perspective view of the threaded insert from FIG. 8.

FIG. 11 is a bottom, side perspective view of the threaded insert from FIG. 8.

FIG. 12 is a plan bottom view of the threaded insert from FIG. 8.

FIG. 13 is a top view of another embodiment of a threaded insert adapted to be installed in an unthreaded, tapered hole in a workpiece formed of a cast material.

FIG. 14 is a partial cross-section view through the threaded insert of FIG. 4 taken along lines 14-14 in FIG. 13.

FIG. 15 is a cross-section view through the threaded insert of FIG. 14 taken along lines 15-15 in FIG. 13 showing a relief in a distal portion of the inside of the tubular shank to enhance packaging.

FIG. 16 is a cross-section view through a workpiece that was cast with a hole configured to subsequently receive the threaded insert of FIGS. 13-15 without post-processing.

FIG. 17 is a top view of a tapered fastener in the form of a screw adapted to be installed in an unthreaded, tapered hole in a workpiece formed of a cast material.

FIG. 18 is a side view of the screw of FIG. 17.

FIG. 19 is a cross-section view through a workpiece that was cast with a hole configured to subsequently receive the screw of FIGS. 17 and 18.

FIG. 20 is a top view of a tapered fastener in the form of a double ended stud adapted to be installed in an unthreaded, tapered hole in a workpiece formed of a cast material.

FIG. 21 is a side view of the double ended stud of FIG. 20.

FIG. 22 is a cross-section view through a workpiece that was cast with a hole configured to subsequently receive the double ended stud of FIGS. 20 and 21.

### DETAILED DESCRIPTION

Generally described, one or more aspects of the present disclosure relate to a tapered fastener (e.g., inserts, screws, bolts, studs, rivets, anchors, etc.) insertable into a tapered aperture or hole of a cast material. In certain embodiments, the tapered fastener provides a female thread for subsequent insertion of a screw or bolt. In certain embodiments, the disclosure relates to a tapered fastener adapted to be installed in an unthreaded, tapered hole in a workpiece formed of a cast material is provided. The tapered fastener can have a head and a shank (solid, tubular, etc). The shank can have a tapering outer face with substantially the same tapering angle as the tapered hole in the workpiece. A thread forming screw thread in the tapering outer face forms threads in the unthreaded, tapered hole as the head drives the tubular shank into the workpiece. In certain embodiments, a screw thread is formed inside the shank to receive a threaded fastener.

The tapered fasteners disclosed herein are designed to be directly installed in holes of a casting (e.g., non-ferrous castings) without requiring post-processing to machine the hole to remove any taper. Exemplary cast materials can include non-ferrous metals (e.g., aluminum, copper, lead, nickel, tin, titanium and zinc, as well as copper alloys like brass and bronze). Of course other materials (e.g., ferrous metals, plastics, etc.) also fall within the scope of this disclosure.

In certain embodiments, the hole has a taper of 4 degrees. Of course the magnitude of the taper is not limited to 4 degrees and can be above or below 4 degrees. For example, the taper of the hole can be 2 degrees. 2.5 degrees, 3 degrees, 3.5 degrees, 4.5 degrees, 5 degrees, 5.5 degrees, 6 degrees, 6.5 degrees, 7 degrees, etc. including values within and ranges of the listed values. The shank can have a substantially same taper angle as the tapered hole in the workpiece. Of course the tapers need not be substantially the same to fall within the scope of this disclosure. For example, in certain embodiments, the taper of the shank is within 1.5 degrees of the taper of the hole. In other embodiments, the taper of the shank is within 2 degrees of the taper of the hole. In other embodiments, the taper of the shank is within 2.5 degrees of the taper of the hole. In other embodiments, the taper of the shank is within 3 degrees of the taper of the hole. Other magnitudes of the difference between the taper of the shank and the taper of the hole fall within the scope of this disclosure.

In this way, the tapered fastener disclosed herein obviate the need for post-processing the hole in preparing for insert installation in the workpiece; allow holes to be cast with easily achievable tapers (e.g., larger) in contrast to requiring to cast straight or very slight tapered holes (e.g., <1.5 degrees of taper) for mass produced parts. For example, straight or slightly tapered holes can cause the part to stick within the manufacturing die prolonging manufacturing time. By allowing larger tapered holes which are less likely to stick within the manufacturing die, for example, the manufacturing casting process is more efficient without creating a need for post-processing of the larger tapered holes.

The fasteners disclosed herein are easier to align with the hole due to the tapering shapes of the fastener and/or hole. For example, a distal end of the fastener can be simply dropped into the hole and achieve adequate alignment for be driven without the need for a robust alignment process. Such an advantage simplifies the assembly process saving time and cost.

The fasteners disclosed herein can further provide an increased tensile pull-out strength as compared to straight fasteners. For example, the tapering or conical shape of the fastener forms a wedge like action within the hole that results in hoop stresses being created in the workpiece or casting. The hoop stresses multiply the friction at the interface between the casting and the fastener increasing pull-out strength over straight fasteners.

The assembly weight of the fastener acid the workpiece can be less when compared to a workpiece that has non-tapered holes even though the density of the tapered fastener (e.g., steel) can be higher than the as-cast material (e.g., aluminum). This weight savings is partly due to the holes being slightly smaller than non-tapered holes.

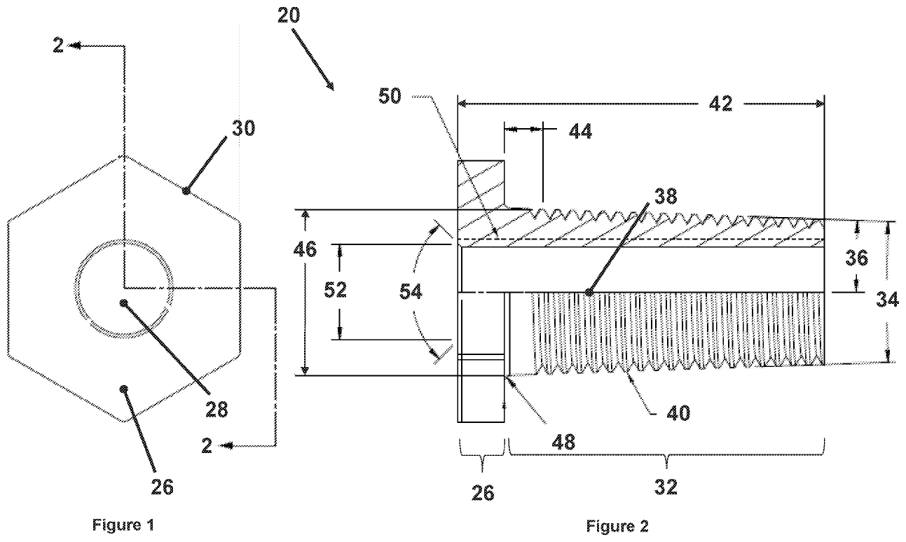

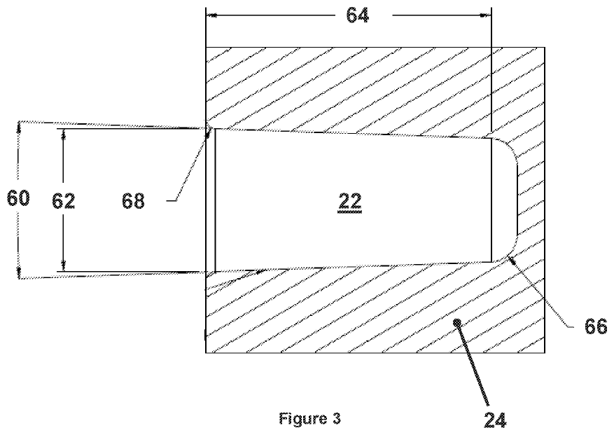

FIG. 1 is a top view of a tapered fastener in the form of an insert 20 adapted to be installed in an unthreaded, tapered hole 22 (FIG. 3) in a workpiece 24. In certain embodiments, the workpiece 24 is formed of a cast material. FIG. 2 is a partial cross-section view through the threaded insert 20 of FIG. 1 taken along lines 2-2. in FIG. 1. In certain embodiments, the threaded insert 20 includes a taper 34. FIG. 3 is a cross-section view through a workpiece 24 that was cast with a hole 22 configured to subsequently receive the threaded insert 20 of FIGS. 1 and 2. In the illustrated embodiment, the hole 22 in the workpiece 24 has diameter 62 and a taper 60. The threaded insert 20 disclosed herein are designed to be directly installed in the hole 22 of the workpiece 24 (e.g., non-ferrous castings) without requiring post-processing to machine the hole 22 after casting the workpiece 24. For, example, the threaded inserts 20 disclosed herein can be aligned and driven into the hole 22 without having to machine the hole to cut away the as-cast taper of the hole 22.

In certain embodiments, the hole 22 has a taper 60 of about 4 degrees. Of course the magnitude of the taper 60 is not limited to 4 degrees and can be above or below 4 degrees. For example, the taper 60 of the hole 22 can be 2 degrees, 2.5 degrees, 3 degrees, 3,5 degrees, 4.5 degrees, 5 degrees, 5.5 degrees, 6 degrees, 6.5 degrees, 7 degrees, etc. including values within and ranges of the listed values.

In certain embodiments, the workpiece 24 comprises a countersink 68 formed at the top of the hole 22. In certain embodiments, the countersink 68 can insure that the threaded insert 20 is easy to align with the hole 22. In certain embodiments, the countersink 68 can be deep or shallow relative to the workpiece 24. For example, in certain embodiments, the countersink 68 can insure that the threaded insert 20 sits flush to the workpiece 24. In certain embodiments, the countersink 68 produces a conical opening for the hole 22 matching an angle on the threaded insert 20 (e.g., an tapered head 26) so that when the threaded insert 20 is fully engaged the head 26 will sit flush or slightly below the surface of the workpiece 24. In certain embodiments, a bottom of the hole 22 comprises a radius 66.

In certain embodiments, the threaded insert 20 includes a head 26 and a shank 32. In the illustrated embodiments, a radius 48 joins surfaces of the head 26 and the shank 32. The head 26 can comprise aperture 28 configured for a fastener 200 to be inserted therein after the threaded insert 20 is installed in the workpiece 24. In certain embodiments, the threaded insert 20 is made of a higher tensile strength and harder material than the workpiece 24, such as a steel, including stainless or spring steel. Of course other materials for the threaded insert 20 fall within the scope of this disclosure.

The fastener 200 can be any type of fastener such as a threaded screw or bolt, etc. Of course the fastener 200 can be a different type of fastener (e.g., plug, rivet, pin, stud, etc.) that is complementary to the internal channel within the threaded insert 20. In exemplary use, the fastener 200 can provide hold-down capability to engage another item (not shown) to the workpiece 24, or can act as an electrical contact post or electrical connection for the workpiece 24.

The head 26 can include a driving arrangement 30. The driving arrangement 30 can be sized and shaped to be engaged by a wrench, ratchet, drill, impact wrench, or other driving tool known to a person having ordinary skill in the art. Air powered or pneumatic tools are also within the scope of this disclosure. In the illustrated embodiment, the driving arrangement 30 is a hex head.

The shank 32 can have a generally tubular or hollow shape. For example, in certain embodiments, the shank 32 includes an internal channel. In certain embodiments, the shank 32 has a tapering outer face, In certain embodiments, the shank 32 has substantially the same angle of taper 34 as the taper 60 of the hole 22 in the workpiece 24. Of course, the taper 34 of the shank 32 and the taper 60 of the hole 22 need not be the same. In certain embodiments, the taper 34 of the shank 32 is different from the taper 60 of the hole 22. For example, in certain embodiments, the taper 34 of the shank 32 is within 1.5 degrees of the taper 60 of the hole 22. In other embodiments, the taper 34 of the shank 32 is within 2 degrees of the taper 60 of the hole 22. In other embodiments, the taper 34 of the shank 32 is within 2.5 degrees of the taper 60 of the hole 22. In other embodiments, the taper 34 of the shank 32 is within 3 degrees of the taper 60 of the hole 22. Other magnitudes of the difference between the taper 34 of the shank 32 and the taper 60 of the hole 22 fall within the scope of this disclosure.

In certain embodiments, the tapering outer face has a maximum outer diameter 46. In certain embodiments, the hole 22 in the workpiece 24 has a minimum inner diameter. In certain embodiments, the maximum outer diameter 46 is greater than that of the minimum inner diameter of the hole 22 in the workpiece 24. In certain embodiment, the taper 34 can extend for the longitudinal length of the shank 32. In certain embodiment, the taper 34 extends for at least a portion of the longitudinal length of the shank 32.

In certain embodiments, a taper 36 is measured with reference to a centerline 38 of the threaded insert 20. In the illustrated embodiment, the taper 36 corresponds to half of the magnitude of the taper 34.

In certain embodiments, the threaded insert 20 comprises a thread forming screw thread 40 (e.g., asymmetrical thread). In certain embodiments, the thread forming screw thread 40 comprises 3, 5, or 7 lobes. In certain embodiments, the thread forming screw thread 40 is disposed in the tapering outer face of the shank 32. In certain embodiments, the thread forming screw thread 40 has a pitch and a depth which are substantially the same. In certain embodiments, the thread forming screw thread 40 has a parabolic shape. In certain embodiments, the thread forming screw thread 40 is trilobular or pentalobular. In certain embodiments, the thread forming profile can have at least a partial section of the thread 40 designed as an asymmetrical thread (e.g., three-lobed). For example, a trilobular thread can have a cross-section with three-sides of equal thickness.

In certain embodiments, the thread forming screw thread 40 forms threads in the unthreaded, tapered hole 22 of the workpiece as the head 26 drives the shank 32 into the workpiece 24. For example, in certain embodiments, the thread forming screw thread 40 roll-forms the threads in the unthreaded, tapered hole 22 of the workpiece 24 as the head 26 drives the shank 32 into the workpiece 24 pushing excess material out of the way by plastic deformation.

The formed threads in the hole 22 are sized and shaped to receive the fastener 200. In certain embodiments, the thread forming screw thread 40 begins a distance 44 from a bottom surface of the head 26. The shank 32 of the threaded insert 20 is generally completely received within a thickness 64 of the workpiece 24 in a general direction parallel to the thickness 64. In certain embodiments, the threaded insert 20 has a length 42.

In certain embodiments, the aperture 28 in the head 26 extends through the shank 32. For example, in the illustrated embodiment, the aperture 28 extends for the entire length of the shank 32. In the illustrated embodiment, the aperture has a diameter 52. In the illustrated embodiment, the diameter 52 is sized to receive a 14 mm fastener 200. Of course the diameter 52 is not limited to the listed size and can have any other size (e.g., 8 mm, 10 mm, 12 mm, 16 mm, etc.). The aperture 28 is sized to receive the fastener 200.

In certain embodiments, the threaded insert 20 comprises a countersink 54 formed at the top of the aperture 28 in the head 26. In certain embodiments, the countersink 54 can insure that a fastener 200 (e.g., flat head screw, flat head bolt) sits flush to the head 26. In certain embodiments, the countersink 68 produces a conical opening for the hole 22 matching the angle of the fastener 200 so that when the fastener 200 is fully engaged, the head of the fastener 200 will sit flush or slightly below the surface of the threaded insert 20.

In certain embodiments, the threaded insert 20 comprises a screw thread 50. In certain embodiments, the screw thread 50 is disposed inside the tubular shank 32. In certain embodiments, the screw thread 50 has a pitch and a depth which are substantially the same. In certain embodiments, the screw thread 50 is configured to receive the fastener 200.

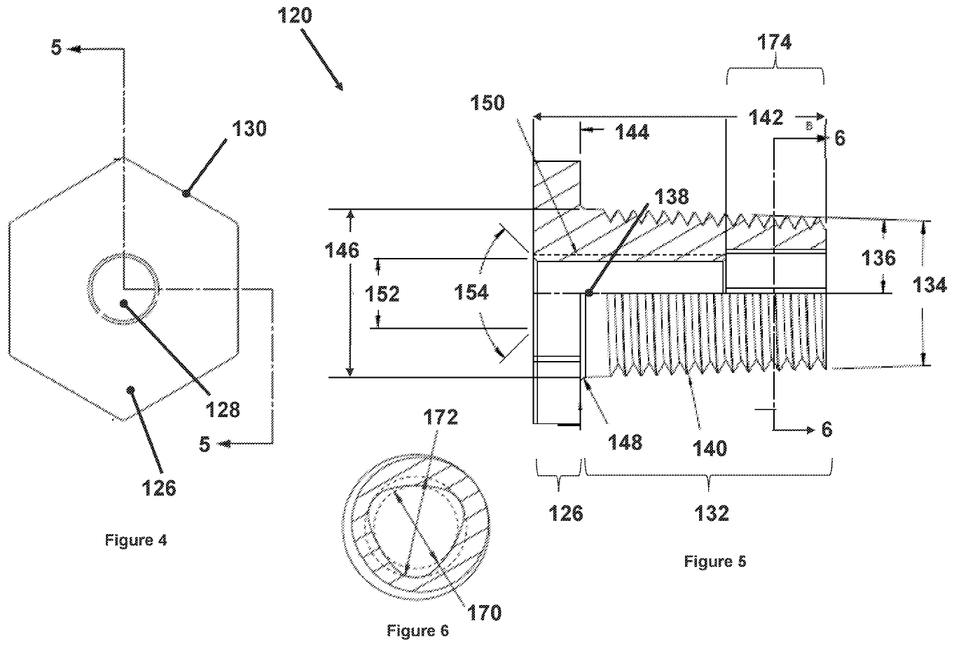

FIG. 4 is a top view of another embodiment of a threaded insert 120 adapted to be installed in an unthreaded, tapered hole 122 in a workpiece 124 formed of a cast material. FIG. 5 is a partial cross-section view through the threaded insert 122 of FIG. 4 taken along lines 5-5 in FIG. 4. In certain embodiments, the threaded insert 120 includes a taper 134. FIG. 6 is a cross-section view through the threaded insert 120 of FIG. 5 taken along lines 6-6 in FIG. 5 showing a relief 174 in a distal portion of the inside of the tubular shank 131 The relief 174 can improve packaging for the threaded insert 120. In certain embodiments, the relief 174 can have a minimum inner diameter 170 and a maximum outer diameter 172.

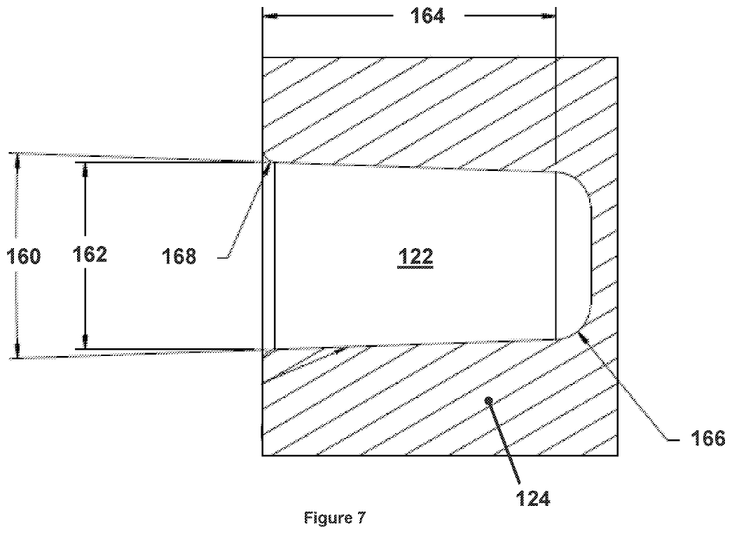

FIG. 7 is a cross-section view through a workpiece 124 that was cast with a hole 122 configured to subsequently receive the threaded insert 120 of FIGS. 4-6 without post-processing. In the illustrated embodiment, the hole 122 in the workpiece 124 has diameter 162 and a taper 160. The threaded insert 120 disclosed herein are designed to be directly installed in the hole 122 of the workpiece 124 (e.g., non-ferrous castings) without requiring post-processing after the workpiece 124 is cast to machine the hole 122 removing any taper. In certain embodiments, the hole 122 has a taper 160 of 4 degrees. Of course the magnitude of the taper 160 is not limited to 4 degrees and can be above or below 4 degrees. For example, the taper 160 of the hole 122 can be 2 degrees, 2.5 degrees, 3 degrees, 3.5 degrees, 4.5 degrees, 5 degrees, 5.5 degrees, 6 degrees, 6.5 degrees, 7 degrees, etc. including values within and ranges of the listed values.

In certain embodiments, the workpiece 124 comprises a countersink 168 formed at the top of the hole 122. In certain embodiments, the countersink 168 can insure that the threaded insert 120 is easy to align with the hole 122. In certain embodiments, the countersink 168 can be deep or shallow relative to the workpiece 124. For example, in certain embodiments, the countersink 168 can insure that the threaded insert 120 sits flush to the workpiece 124. in certain embodiments, the countersink 168 produces a conical opening for the hole 122 matching an angle on the threaded insert 120 (e.g., an tapered head 126) so that when the threaded insert 120 is fully engaged the head 126 will sit flush or slightly below the surface of the workpiece 124. In certain embodiments, a bottom of the hole 122 comprises a radius 166.

In certain embodiments, the threaded insert 120 includes a head 126 and a shank 132. In the illustrated embodiments, a radius 148 joins surfaces of the head 126 and the shank 132. The head 126 can comprise aperture 128 configured for a fastener 200 to be inserted therein after the threaded insert 120 is installed in the workpiece 124. In certain embodiments, the threaded insert 120 is made of a higher tensile strength and harder material than the workpiece 124, such as a steel, including stainless or spring steel. Of course other materials for the threaded insert 120 fall within the scope of this disclosure.

The fastener 200 can be any type of tapered fastener such as a screw or bolt, etc. Of course the fastener 200 can be a different type of fastener (e.g., plug, keyway, etc.) that is complementary to the internal channel within the threaded insert 120. In exemplary use, the fastener 200 can provide hold-down capability to engage another item not shown) to the workpiece 124, or can act as an electrical contact post or electrical connection for the workpiece 124.

The head 126 can include a driving arrangement 130. The driving arrangement 130 can be sized and shaped to be engaged by a wrench, ratchet, drill, impact wrench, or other driving tool known to a person having ordinary skill in the art. Air powered or pneumatic tools are also within the scope of this disclosure. In the illustrated embodiment, the driving arrangement 130 is a hex head.

The shank 132. can have a generally tubular or hollow shape. For example, in certain embodiments, the shank 132 includes an internal channel. In certain embodiments, the shank 132 has a tapering outer face. In certain embodiments, the shank 132 has substantially the same angle of taper 134 as the taper 160 of the hole 122 in the workpiece 124. Of course, the taper 134 of the shank 132 and the taper 160 of the hole 122 need not be the same. In certain embodiments, the taper 134 of the shank 132 is different from the taper 160 of the hole 122. For example, in certain embodiments, the taper 134 of the shank 132 is within 1.5 degrees of the taper 160 of the hole 122. In other embodiments, the taper 134 of the shank 132 is within 2 degrees of the taper 160 of the hole 122. In other embodiments, the taper 134 of the shank 132 is within 2.5 degrees of the taper 160 of the hole 122. In other embodiments, the taper 134 of the shank 132 is within 3 degrees of the taper 160 of the hole 122. Other magnitudes of the difference between the taper 134 of the shank 132 and the taper 160 of the hole 122 fall within the scope of this disclosure.

100961 In certain embodiments, the tapering outer face has a maximum outer diameter 146. Tn certain embodiments, the hole 122 in the workpiece 124 has a minimum inner diameter. In certain embodiments, the maximum outer diameter 146 is greater than that of the minimum inner diameter of the hole 122 in the workpiece 124. Tn certain embodiment, the taper 134 can extend for the longitudinal length of the shank 132. In certain embodiment, the taper 134 extends for at least a portion of the longitudinal length of the shank 132.

In certain embodiments, a taper 136 is measured with reference to a centerline 138 of the threaded insert 120. In the illustrated embodiment, the taper 136 corresponds to half of the magnitude of the taper 134.

In certain embodiments, the threaded insert 120 comprises a thread forming screw thread 140 (e.g., asymmetrical thread). In certain embodiments, the thread forming screw thread 140 comprises 3, 5, or 7 lobes. In certain embodiments, the thread forming screw thread 140 is disposed in the tapering outer face of the shank 132. In certain embodiments, the thread forming screw thread 140 has a pitch and a depth which are substantially the same. In certain embodiments, the thread forming screw thread 140 has a parabolic shape. In certain embodiments, the thread forming screw thread 140 is trilobular or pentalobular. In certain embodiments, the thread forming profile can have at least a partial section of the thread 140 designed as an asymmetrical thread (e.g., three-lobed). For example, the trilobular thread can have a cross-section with three-sides of equal thickness.

in certain embodiments, the thread forming screw thread 140 forms threads in the unthreaded, tapered hole 122 of the workpiece as the head 126 drives the shank 132 into the workpiece 124. For example, in certain embodiments, the thread forming screw thread 140 roll-forms the threads in the unthreaded, tapered hole 122 of the workpiece 124 as the head 126 drives the shank 132 into the workpiece 124 pushing excess material out of the way by plastic deformation.

The formed threads in the hole 122 are sized and shaped to receive the fastener 200. In certain embodiments, the thread forming screw thread 140 begins a distance 144 from a bottom surface of the head 126. The shank 132 of the threaded insert 120 is generally completely received within a thickness 164 of the workpiece 124 in a general direction parallel to thickness 164. In certain embodiments, the threaded insert 120 has a length 142.

In certain embodiments, the aperture 128 in the head 126 extends through the shank 132. For example, in the illustrated embodiment, the aperture 128 extends for the entire length of the shank 132. In the illustrated embodiment, the aperture has a diameter 152, In the illustrated embodiment, the diameter 152 is sized to receive a 10 mm fastener 200. Of course the diameter 152 is not limited to the listed size and can have any other size (e.g., 8 mm, 12 mm, 14 mm, 16 mm, etc.). The aperture 128 is sized to receive the fastener 200.

In certain embodiments, the threaded insert 120 comprises a countersink 154 formed at the top of the aperture 128 in the head 126. In certain embodiments, the countersink 154 can insure that a fastener 200 (e.g., flat head screw, flat head bolt) sits flush to the head 126. In certain embodiments, the countersink 168 produces a conical Opening for the hole 122 matching the angle of the fastener 200 so that when the fastener 200 is fully engaged, the head of the fastener 200 will sit flush or slightly below the surface of the threaded insert 120.

In certain embodiments, the threaded insert 120 comprises a screw thread 150. In certain embodiments, the screw thread 150 is disposed inside the tubular shank 132.

In certain embodiments, the screw thread 150 has a pitch and a depth which are substantially the same. In certain embodiments, the screw thread 150 is configured to receive the fastener 200.

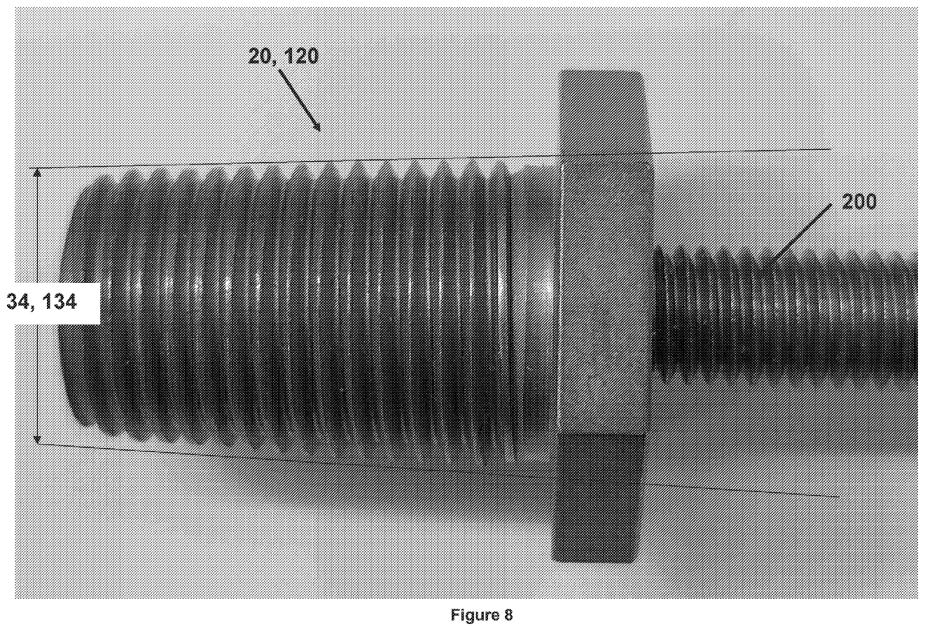

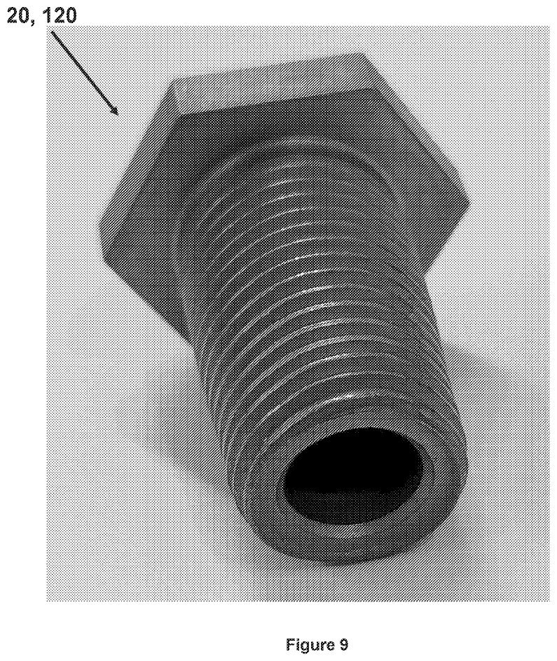

FIG. 8 is side view of the threaded insert 20, 120 with a threaded fastener 200 secured therein. FIG. 9 is a bottom perspective view of the threaded insert 20, 120 from FIG. 8. In certain embodiments, the shank 32, 132 has a tapering outer face with substantially the same angle of taper 34, 134 as the taper 60, 160 of the hole 22, 122 in the workpiece 24, 124. Of course, the taper 34, 134 of the shank 32, 132 and the taper 60, 160 of the hole 22, 122 need not be the same. In certain embodiments, the taper 34, 134 of the shank 32, 132 is different from the taper 60, 160 of the hole 22, 122. For example, in certain embodiments, the taper 34, 134 of the shank 32, 132 is within 1.5 degrees of the taper 60, 160 of the hole 22, 122. In other embodiments, the taper 34, 134 of the shank 32, 132 is within 2 degrees of the taper 60, 160 of the hole 22, 122. In other embodiments, the taper 34, 134 of the shank 32, 132 is within 2.5 degrees of the taper 60, 160 of the hole 22, 122. In other embodiments, the taper 34, 134 of the shank 32, 132 is within 3 degrees of the taper 60, 160 of the hole 22, 122. Other magnitudes of the difference between the taper 34, 134 of the shank 32, 132 and the taper 60, 160 of the hole 22, 122 fall within the scope of this disclosure.

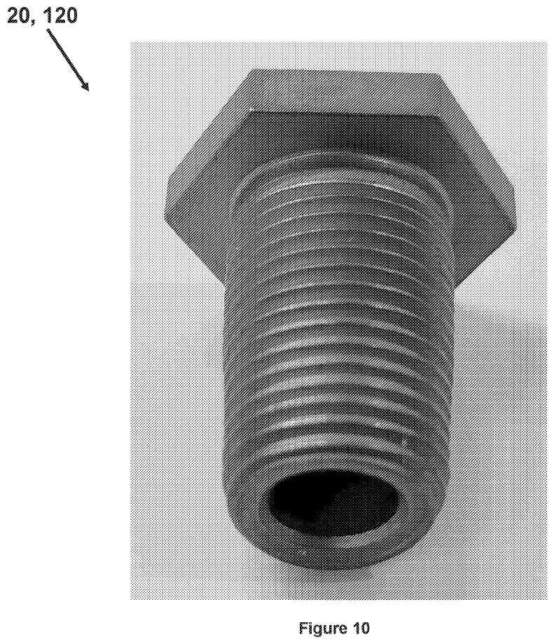

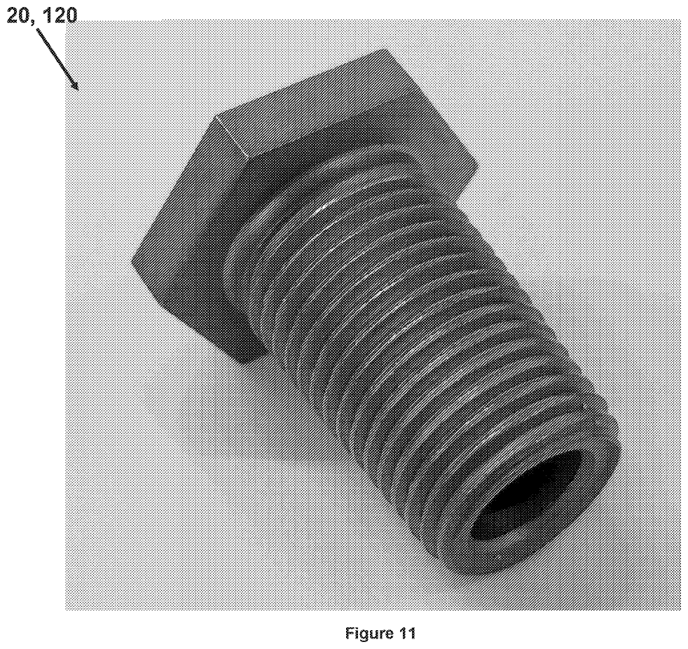

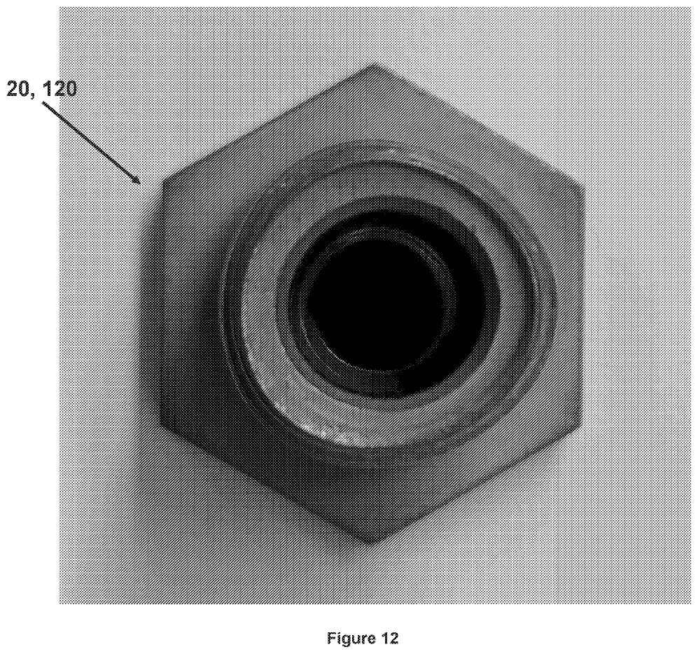

FIG. 10 is another bottom perspective view of the threaded insert from FIG. 8, FIG. 11 is a bottom, side perspective view of the threaded insert from FIG. 8. FIG. 12 is a plan bottom view of the threaded insert from FIG. 8. In certain embodiments, the tapering outer face has a maximum outer diameter 46, 146 greater than that of a minimum inner diameter of the hole 22, 122 in the workpiece 24. 124. In certain embodiment, the taper 34, 134 can extend for the longitudinal length of the shank 32, 132.

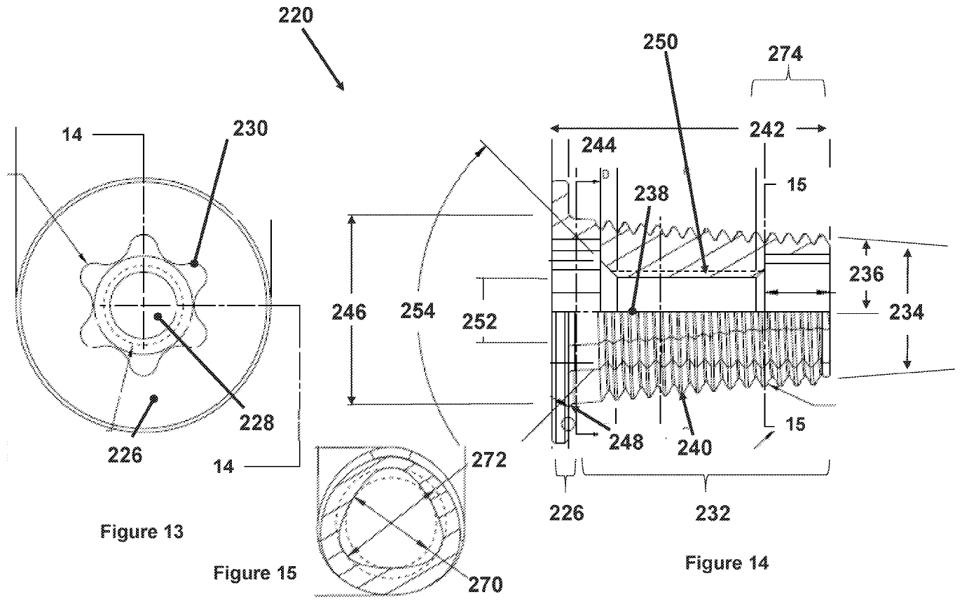

FIG. 13 is a top view of another embodiment of a threaded insert 220 adapted to be installed in an unthreaded, tapered hole 222 in a workpiece 224 formed of a cast material. FIG. 14 is a partial cross-section view through the threaded insert 222 of FIG. 13 taken along lines 14-44 in FIG. 13. In certain embodiments, the threaded insert 220 includes a taper 234. FIG. 15 is a cross-section view through the threaded insert 220 of FIG. 14 taken along lines 15-15 in FIG. 14 showing a relief 274 in a distal portion of the inside of the tubular shank 232. The relief 274 can improve packaging for the threaded insert 220. In certain embodiments, the relief 274 can have a minimum inner diameter 270 and a maximum outer diameter 272.

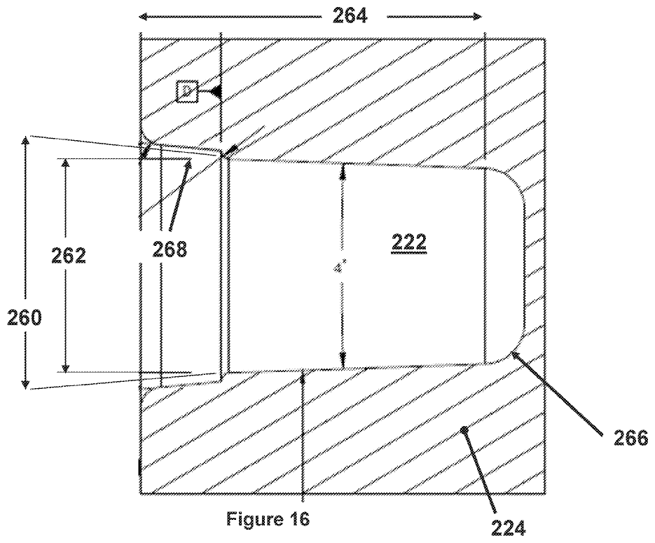

FIG. 16 is a cross-section view through a workpiece 224 that was cast with a hole 222 configured to subsequently receive the threaded insert 220 of FIGS. 13-15 without post-processing. In the illustrated embodiment, the hole 222 in the workpiece 224 has diameter 262 and a taper 260. The threaded insert 220 disclosed herein is designed to be directly installed in the hole 222 of the workpiece 224 (e.g., non-ferrous castings) without requiring post-processing after the workpiece 224 is cast to machine the hole 222 removing any taper. In certain embodiments, the hole 222 has a taper 260 of 4 degrees. Of course the magnitude of the taper 260 is not limited to 4 degrees and can be above or below 4 degrees. For example, the taper 260 of the hole 222 can be 2 degrees, 2.5 degrees, 3 degrees, 3.5 degrees, 4.5 degrees, 5 degrees, 5.5 degrees, 6 degrees, 6.5 degrees, 7 degrees, etc. including values within and ranges of the listed values.

In certain embodiments, the workpiece 224 comprises a countersink 268 formed at the top of the hole 222. In certain embodiments, the countersink 268 can insure that the threaded insert 220 is easy to align with the hole 222. In certain embodiments, the countersink 268 can be deep or shallow relative to the workpiece 224. In certain embodiments, a bottom of the hole 222 comprises a radius 266.

In certain embodiments, the threaded insert 220 includes a head 226 and a shank 232. In the illustrated embodiments, a radius 248 joins surfaces of the head 226 and the shank 232. The head 226 can comprise aperture 228 configured for a fastener 200 to be inserted therein after the threaded insert 220 is installed in the workpiece 224. In certain embodiments, the threaded insert 220 is made of a higher tensile strength and harder material than the workpiece 224, such as a steel, including stainless or spring steel. Of course other materials for the threaded insert 220 fall within the scope of this disclosure.

The fastener 200 can be any type of threaded fastener such as a screw or bolt, etc. Of course the fastener 200 can be a different type of fastener (e.g., plug, keyway, etc.) that is complementary to the internal channel within the threaded insert 220. In exemplary use, the fastener 200 can provide hold-down capability to engage another item (not shown) to the workpiece 224, or can act as an electrical contact post or electrical connection for the workpiece 224.

The head 226 can include a driving arrangement 230. The driving arrangement 230 can be sized and shaped to be engaged by a wrench, ratchet, drill, impact wrench, hex, or other driving tool known to a person having ordinary skill in the art. Air powered or pneumatic tools are also within the scope of this disclosure. In the illustrated embodiment, the driving arrangement 230 is a hex head.

The shank 232 can have a generally tubular or hollow shape. For example, in certain embodiments, the shank 232 includes an internal channel. In certain embodiments, the shank 232 has a tapering outer face. In certain embodiments, the shank 232 has substantially the same angle of taper 234 as the taper 260 of the hole 222 in the workpiece 224. Of course, the taper 234 of the shank 232 and the taper 260 of the hole 222 need not be the same. In certain embodiments, the taper 234 of the shank 232 is different from the taper 260 of the hole 222. For example, in certain embodiments, the taper 234 of the shank 232 is within 1.5 degrees of the taper 260 of the hole 222. In other embodiments, the taper 234 of the shank 232 is within 2 degrees of the taper 260 of the hole 222. In other embodiments, the taper 234 of the shank 232 is within 2.5 degrees of the taper 260 of the hole 222. In other embodiments, the taper 234 of the shank 232 is within 3 degrees of the taper 260 of the hole 222. Other magnitudes of the difference between the taper 234 of the shank 232 and the taper 260 of the hole 222 fall within the scope of this disclosure.

In certain embodiments, the tapering outer face has a maximum outer diameter 246. In certain embodiments, the hole 222 in the workpiece 224 has a minimum inner diameter. In certain embodiments, the maximum outer diameter 246 is greater than that of the minimum inner diameter of the hole 222 in the workpiece 224. In certain embodiment, the taper 234 can extend for the longitudinal length of the shank 232. In certain embodiment, the taper 234 extends for at least a portion of the longitudinal length of the shank 232.

In certain embodiments, a taper 236 is measured with reference to a centerline 238 of the threaded insert 220. In the illustrated embodiment, the taper 236 corresponds to half of the magnitude of the taper 234.

In certain embodiments, the threaded insert 220 comprises a thread forming screw thread 240 (e.g., asymmetrical thread). In certain embodiments, the thread forming screw thread 240 comprises 3, 5, or 7 lobes. In certain embodiments, the thread forming screw thread 240 is disposed in the tapering outer face of the shank 232. In certain embodiments, the thread forming screw thread 240 has a pitch and a depth which are substantially the same. In certain embodiments, the thread forming screw thread 240 has a parabolic shape. In certain embodiments, the thread forming screw thread 240 is trilobular or pentalobular. In certain embodiments, the thread forming profile can have at least a partial section of the thread 240 designed as an asymmetrical thread (e.g., three-lobed). For example, the trilobular thread can have a cross-section with three-sides of equal thickness.

In certain embodiments, the thread forming screw thread 240 forms threads in the unthreaded, tapered hole 222 of the workpiece as the head 226 drives the shank 232 into the workpiece 224. For example, in certain embodiments, the thread forming screw thread 240 roll-forms the threads in the unthreaded, tapered hole 222 of the workpiece 224 as the head 226 drives the shank 232 into the workpiece 224 pushing excess material out of the way by plastic deformation.

The formed threads in the hole 222 are sized and shaped to receive the fastener 200. In certain embodiments, the thread forming screw thread 240 begins a distance 244 from a bottom surface of the head 226. The shank 232 of the threaded insert 220 is generally completely received within a thickness 264 of the workpiece 224 in a general direction parallel to thickness 264. In certain embodiments, the threaded insert 220 has a length 242.

In certain embodiments, the aperture 228 in the head 226 extends through the shank 232. For example, in the illustrated embodiment, the aperture 228 extends for the entire length of the shank 232. In the illustrated embodiment, the aperture has a diameter 252. In the illustrated embodiment, the diameter 252 is sized to receive a 10 mm fastener 200. Of course the diameter 252 is not limited to the listed size and can have any other size (e.g., 8 mm, 12 mm, 14 mm, 16 mm, etc.). The aperture 228 is sized to receive the fastener 200.

In certain embodiments, the threaded insert 220 comprises a countersink 254 formed at the top of the aperture 228 in the head 226. In certain embodiments, the countersink 254 can insure that a fastener 200 (e.g., flat head screw, flat head bolt) sits flush to the head 226. In certain embodiments, the countersink 268 produces a conical opening for the hole 222 matching the angle of the fastener 200 so that when the fastener 200 is fully engaged, the head of the fastener 200 will sit flush or slightly below the surface of the threaded insert 220.

In certain embodiments, the threaded insert 220 comprises a screw thread 250. In certain embodiments, the screw thread 250 is disposed inside the tubular shank 232. In certain embodiments, the screw thread 250 has a pitch and a depth which are substantially the same. In certain embodiments, the screw thread 250 is configured to receive the fastener 200.

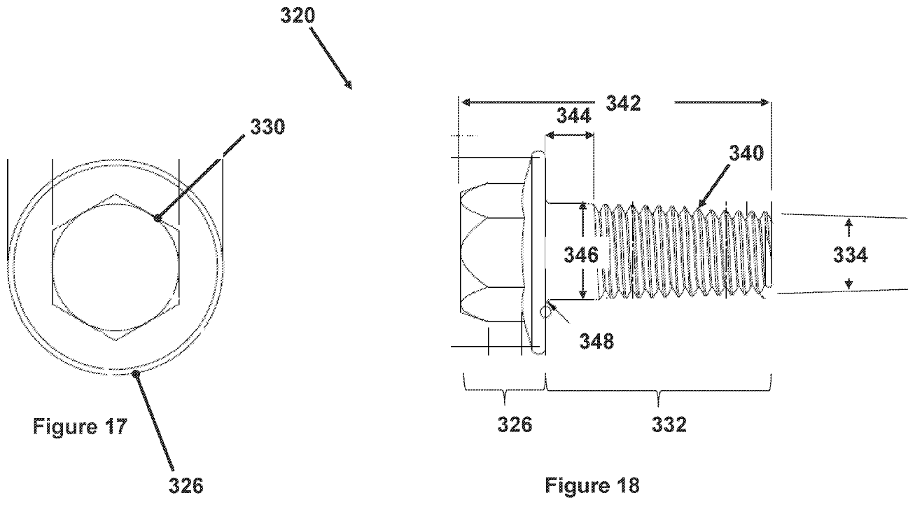

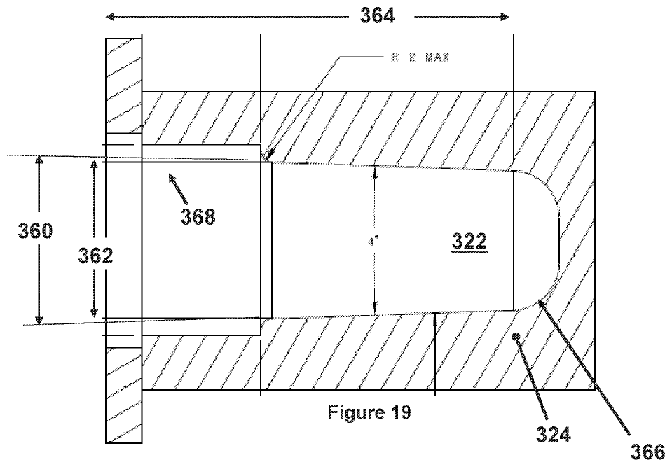

FIG. 17 is a top view of a tapered fastener in the form of a screw 320 adapted to be installed in an unthreaded, tapered hole 322 (FIG. 19) in a workpiece 324. In certain embodiments, the workpiece 24 is formed of a cast material. FIG. 18 is a side view of the screw 320 of FIG. 17. In certain embodiments, the screw 320 includes a taper 334. FIG. 19 is a cross-section view through a workpiece 324 that was cast with a hole 322 configured to subsequently receive the screw 320 of FIGS. 17 and 18. In the illustrated embodiment, the hole 322 in the workpiece 324 has diameter 362 and a taper 360. The screw 320 disclosed herein are designed to be directly installed in the hole 322 of the workpiece 324 (e.g., non-ferrous castings) without requiring post-processing to machine the hole 322 after casting the workpiece 324. For, example, the screw 320 disclosed herein can be aligned and driven into the hole 322 without having to machine the hole to cut away the as-cast taper of the hole 322.

In certain embodiments, the hole 322 has a taper 360 of about 4 degrees. Of course the magnitude of the taper 360 is not limited to 4 degrees and can be above or below 4 degrees. For example, the taper 360 of the hole 322 can be 2 degrees, 2.5 degrees, 3 degrees, 3.5 degrees, 4.5 degrees, 5 degrees, 5.5 degrees, 6 degrees, 6.5 degrees, 7 degrees, etc. including values within and ranges of the listed values.

In certain embodiments, the workpiece 324 comprises a countersink 368 formed at the top of the hole 322. In certain embodiments, the countersink 368 can insure that the screw 320 is easy to align with the hole 322. In certain embodiments, a bottom of the hole 322 comprises a radius 366.

in certain embodiments, the screw 320 includes a head 326 and a shank 332. In the illustrated embodiments, a radius 348 joins surfaces of the head 326 and the shank 332. In certain embodiments, the screw 320 is made of a higher tensile strength and harder material than the workpiece 324, such as a steel, including stainless or spring steel. Of course other materials for the screw 320 fall within the scope of this disclosure.

The screw 320 can provide hold-down capability to engage another item (not shown) to the workpiece 324.

The head 326 can include a driving arrangement 330. The driving arrangement 330 can be sized and shaped to be engaged by a wrench, ratchet, drill, impact wrench, or other driving tool known to a person having ordinary skill in the art. Air powered or pneumatic tools are also within the scope of this disclosure.

The shank 332 can have a generally tubular. In certain embodiments, the shank 332 has a tapering outer face. In certain embodiments, the shank 332 has substantially the same angle of taper 334 as the taper 360 of the hole 322 in the workpiece 324. Of course, the taper 334 of the shank 332 and the taper 360 of the hole 322 need not be the same. In certain embodiments, the taper 334 of the shank 332 is different from the taper 360 of the hole 322. For example, in certain embodiments, the taper 334 of the shank 332 is within 1.5 degrees of the taper 360 of the hole 322. In other embodiments, the taper 334 of the shank 332 is within 2 degrees of the taper 360 of the hole 322. In other embodiments, the taper 334 of the shank 332 is within 2.5 degrees of the taper 360 of the hole 322. In other embodiments, the taper 334 of the shank 332 is within 3 degrees of the taper 360 of the hole 322. Other magnitudes of the difference between the taper 334 of the shank 332 and the taper 360 of the hole 322 fall within the scope of this disclosure.

In certain embodiments, the tapering outer face has a maximum outer diameter 346. In certain embodiments, the hole 322 in the workpiece 324 has a minimum inner diameter. In certain embodiments, the maximum outer diameter 346 is greater than that of the minimum inner diameter of the hole 322 in the workpiece 324. In certain embodiment, the taper 334 can extend for the longitudinal length of the shank 332. In certain embodiment, the taper 334 extends for at least a portion of the longitudinal length of the shank 332.

In certain embodiments, the screw 320 comprises a thread forming screw thread 340 (e.g., asymmetrical thread). In certain embodiments, the thread forming screw thread 340 comprises 3, 5, or 7 lobes. In certain embodiments, the thread forming screw thread 340 is disposed in the tapering outer face of the shank 332. In certain embodiments, the thread forming screw thread 340 has a pitch and a depth which are substantially the same.

In certain embodiments, the thread forming screw thread 340 has a parabolic shape. In certain embodiments, the thread forming screw thread 340 is trilobular or pentalobular. In certain embodiments, the thread forming profile can have at least a partial section of the thread 340 designed as an asymmetrical thread (e.g., three-lobed). For example, a trilobular thread can have a cross-section with three-sides of equal thickness.

In certain embodiments, the thread forming screw thread 340 forms threads in the unthreaded, tapered hole 322 of the workpiece as the head 326 drives the shank 332 into the workpiece 324. For example, in certain embodiments, the thread forming screw thread 340 roll-forms the threads in the unthreaded, tapered hole 322 of the workpiece 324 as the head 326 drives the shank 332 into the workpiece 324 pushing excess material out of the way by plastic deformation.

In certain embodiments, the thread forming screw thread 340 begins a distance 344 from a bottom surface of the head 326. The shank 332 of the screw 320 is generally completely received within a thickness 364 of the workpiece 324 in a general direction parallel to the thickness 364. In certain embodiments, the screw 320 has a length 342.

The head 326 can include a driving arrangement 330, The driving arrangement 330 can be sized and shaped to be engaged by a wrench, ratchet, drill, impact wrench, hex, or other driving tool known to a person having ordinary skill in the art. Air powered or pneumatic tools are also within the scope of this disclosure.

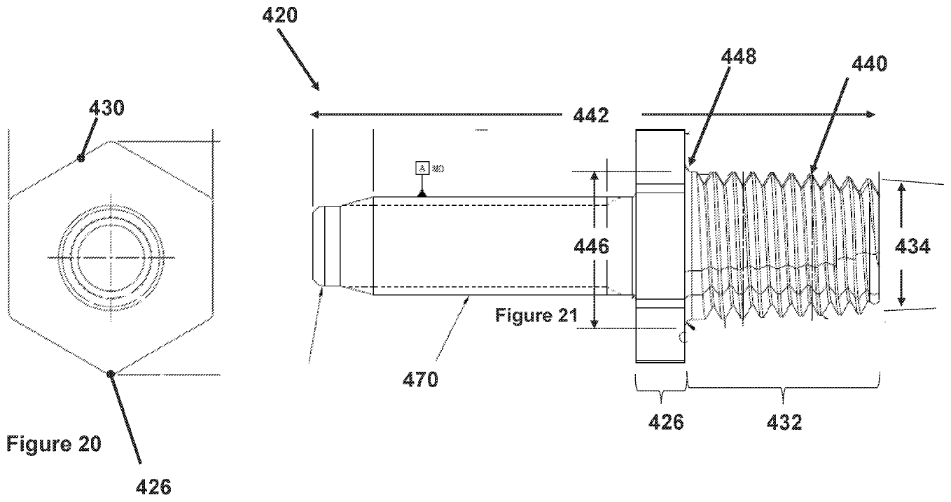

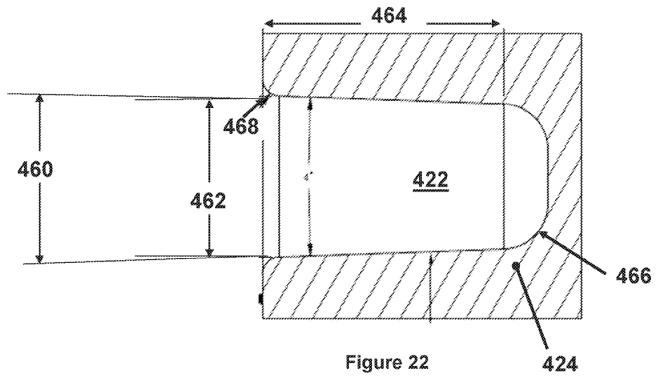

FIG. 20 is a top view of a tapered fastener in the form of a double ended stud 420 adapted to be installed in an unthreaded, tapered hole 422 (FIG. 22) in a workpiece 424. In certain embodiments, the workpiece 424 is formed of a cast material. FIG. 21 is a side view of the double ended stud 420 of FIG. 20. In certain embodiments, the double ended stud 420 includes a taper 434. FIG. 22 is a cross-section view through a workpiece 424 that was cast with a hole 422 configured to subsequently receive the double ended stud 420 of FIGS. 20 and 21. In the illustrated embodiment, the hole 422 in the workpiece 424 has diameter 462 and a taper 460. The double ended stud 420 disclosed herein is designed to be directly installed in the hole 422 of the workpiece 424 (e.g., non-ferrous castings) without requiring post-processing to machine the hole 422 after casting the workpiece 424. For, example, the double ended stud 420 disclosed herein can be aligned and driven into the hole 422 without having to machine the hole to cut away the as-cast taper of the hole 422.

In certain embodiments, the hole 422 has a taper 460 of about 4 degrees. Of course the magnitude of the taper 460 is not limited to 4 degrees and can be above or below 4 degrees. For example, the taper 460 of the hole 422 can be 2 degrees, 2.5 degrees, 3 degrees, 3.5 degrees, 4.5 degrees, 5 degrees, 5.5 degrees, 6 degrees, 6.5 degrees, 7 degrees, etc. including values within and ranges of the listed values.

In certain embodiments, the workpiece 424 comprises a countersink 468 formed at the top of the hole 422. In certain embodiments, the countersink 468 can insure that the double ended stud 420 is easy to align with the hole 422. In certain embodiments, a bottom of the hole 422 comprises a radius 466.

In certain embodiments, the double ended stud 420 includes a head 426, a shank 432, and a stud 470. In certain embodiments, the stud 470 can be plain or threaded. In the illustrated embodiments, a radius 448 joins surfaces of the head 426 and the shank 432. In certain embodiments, the double ended stud 420 is made of a higher tensile strength and harder material than the workpiece 424, such as a steel, including stainless or spring steel. Of course other materials for the double ended stud 420 fall within the scope of this disclosure.

The double ended stud 420 can provide the stud 470 to couple another item (not shown) the workpiece 424.

The head 426 can include a driving arrangement 430. The driving arrangement 430 can be sized and shaped to be engaged by a wrench, ratchet, drill, impact wrench, or other driving tool known to a person having ordinary skill in the art. Air powered or pneumatic-tools are also within the scope of this disclosure.

The shank 432 can have a generally tubular. In certain embodiments, the shank 432 has a tapering outer face. In certain embodiments, the shank 432 has substantially the same angle of taper 434 as the taper 460 of the hole 422 in the workpiece 424. Of course, the taper 434 of the shank 432 and the taper 460 of the hole 422. need not be the same. In certain embodiments, the taper 434 of the shank 432 is different from the taper 460 of the hole 422. For example, in certain embodiments, the taper 434 of the shank 432 is within 1.5 degrees of the taper 460 of the hole 422. In other embodiments, the taper 434 of the shank 432 is within 2 degrees of the taper 460 of the hole 422. In other embodiments, the taper 434 of the shank 432 is within 2.5 degrees of the taper 460 of the hole 422. In other embodiments, the taper 434 of the shank 432 is within 3 degrees of the taper 460 of the hole 422. Other magnitudes of the difference between the taper 434 of the shank 432 and the taper 460 of the hole 422 fall within the scope of this disclosure.

In certain embodiments, the tapering outer face has a maximum outer diameter 446. In certain embodiments, the hole 422 in the workpiece 424 has a minimum inner diameter. In certain embodiments, the maximum outer diameter 446 is greater than that of the minimum inner diameter of the hole 422 in the workpiece 424. In certain embodiment, the taper 434 can extend for the longitudinal length of the shank 432. In certain embodiment, the taper 434 extends for at least a portion of the longitudinal length of the shank 432.

In certain embodiments, the double ended stud 420 comprises a thread forming screw thread 440 (e.g., asymmetrical thread). In certain embodiments, the thread forming screw thread 440 comprises 3, 5, or 7 lobes. In certain embodiments, the thread forming screw thread 440 is disposed in the tapering outer face of the shank 432. In certain embodiments, the thread forming screw thread 440 has a pitch and a depth which are substantially the same. In certain embodiments, the thread forming screw thread 440 has a parabolic shape. In certain embodiments, the thread forming screw thread 440 is trilobular or pentalobular. In certain embodiments, the thread forming profile can have at least a partial section of the thread 440 designed as an asymmetrical thread (e.g., three-lobed). For example, a tri lobular thread can have a cross-section with three-sides of equal thickness.

In certain embodiments, the thread forming screw thread 440 forms threads in the unthreaded, tapered hole 422 of the workpiece as the head 426 drives the shank 432 into the workpiece 424. For example, in certain embodiments, the thread forming screw thread 440 roll-forms the threads in the unthreaded, tapered hole 422 of the workpiece 424 as the head 426 drives the shank 432 into the workpiece 424 pushing excess material out of the way by plastic deformation.

The shank 432 of the double ended stud 420 is generally completely received within a thickness 464 of the workpiece 424 in a general direction parallel to the thickness 464. In certain embodiments, the double ended stud 420 has a length 442.

The head 426 can include a driving arrangement 430. The driving arrangement 430 can be sized and shaped to be engaged by a wrench, ratchet, drill, impact wrench, hex, or other driving tool known to a person having ordinary skill in the art. Air powered or pneumatic tools are also within the scope of this disclosure.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed glove box actuation assembly. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

1. A steel fastener adapted to be installed in an unthreaded, tapered hole in a workpiece formed of a non-ferrous cast metal material, the steel fastener comprising:
a head having a driving arrangement; and
a shank comprising;
a tapering outer face with substantially the same tapering angle as the tapered hole in the workpiece; and
a thread forming screw thread disposed in the tapering outer face and configured to form threads in the unthreaded, tapered hole as the head drives the shank into the workpiece.

2. The steel fastener of claim 1, wherein the head has an aperture, the aperture being sized and shaped to receive a threaded fastener

3. The steel fastener of claim 1, wherein the shank has a generally tubular shape, and wherein the shank comprises a screw thread formed inside the tubular shank and configured to receive a threaded fastener.

4. (canceled)

5. The steel fastener of claim 1, wherein the steel fastener is configured as one of an insert, a screw, or a double ended stud.

6. (canceled)

7. (canceled)

8. (canceled)

9. (canceled)

10. (canceled)

11. The steel fastener of claim 1, wherein the driving arrangement is a rachet.

12. (canceled)

13. (canceled)

14. The steel fastener of claim 1, wherein the tapering angle of the shank is 4 degrees.

15. The steel fastener of claim 14, further comprising the workpiece, wherein the tapering angle of the workpiece is 4 degrees.

16. The steel fastener of claim 1, wherein the thread forming screw thread has a pitch and a depth which are substantially the same.

17. The steel fastener of claim 1, wherein the thread forming screw thread is trilobular.

18. The steel fastener of claim 1, wherein the tapering outer face has a maximum outer diameter greater than that of a minimum inner diameter of the tapered hole in the workpiece.

19. (canceled)

20. The steel fastener of claim 1, wherein the non-ferrous cast metal material is aluminum.

21. (canceled)

22. A steel threaded insert adapted to be installed in an unthreaded, tapered hole in a workpiece formed of a non-ferrous cast metal material, the steel threaded insert comprising:
a head having a driving arrangement and an aperture, the aperture being sized and shaped to receive a threaded fastener; and
a generally tubular shank comprising;
a tapering outer face with substantially the same tapering angle as the tapered hole in the workpiece;
a thread forming screw thread disposed in the tapering outer face and configured to form threads in the unthreaded, tapered hole as the head drives the tubular shank into the workpiece; and
a screw thread formed inside the tubular shank and configured to receive the threaded fastener.

23. (canceled)

24. The steel threaded insert of claim 22, further comprising the workpiece, wherein the tapered hole in the workpiece has a tapering angle greater than 1.5 degrees.

25. The steel threaded insert of claim 22, further comprising the workpiece, wherein a difference between the tapering angle of the workpiece and the tapering angle of the shank is no greater than 1.5 degrees.

26. (canceled)

27. (canceled)

28. The steel threaded insert of claim 22, wherein the thread forming screw thread has a pitch and a depth which are substantially the same.

29. The steel threaded insert of claim 22, wherein the thread forming screw thread is trilobular.

30. (canceled)

31. (canceled)

32. The steel threaded insert of claim 22, further comprising the workpiece, wherein the non-ferrous cast metal material is aluminum.

33. (canceled)

34. A method of installing a steel tapered fastener in an unthreaded, tapered hole in a workpiece formed of a non-ferrous cast metal material, the method comprising:
providing a steel tapered fastener having a head and shank, the head comprising a driving arrangement, the shank comprising a tapering outer face with substantially the same tapering angle as the tapered hole in the workpiece, the tapering outer face comprising a thread forming screw thread;
inserting at least a portion of the shank into the unthreaded, tapered hole; and
driving the fastener via the driving arrangement into the unthreaded, tapered hole to form threads in the unthreaded, tapered hole.

35. The method of claim 34, further comprising pushing excess material out of the unthreaded, tapered hole by plastic deformation.

36. The method of claim 34, further comprising coupling a second fastener to the steel tapered fastener.
